(19) United States
(12) Patent Application Publication
(10) Pub. No.: US 2026/0154199 A1
(43) Pub. Date: Jun. 4, 2026

(54) ATS Endpoint Optimization For Storage Workloads

(71) Applicant: Sandisk Technologies, Inc., Milpitas, CA (US)

(72) Inventors: Shay BENISTY, Beer Sheva (IL); Judah Gamliel HAHN, Ofra (IL); Ariel NAVON, Revava (IL); Alexander BAZARSKY, Holon (IL)

(73) Assignee: Sandisk Technologies, Inc., Milpitas, CA (US)

(21) Appl. No.: 18/967,890

(22) Filed: Dec. 4, 2024

(51) Int. Cl. G06F 12/0802; G06F 12/1027

(52) U.S. Cl. CPC G06F 12/0802; G06F 12/1027

(57) ABSTRACT

Rather than simply providing an address translation cache (ATC) with a global approach that ignores client needs or providing a static ATC that ignores performance changes, the ATC allocation can be dynamically adjusted. The dynamic allocation optimizes the overall system performance will constraining the performance of each individual client when necessary. The dynamic approach involves periodically, or strategically, determining whether the currently in use ATC allocation results in the performance desired. The dynamic reallocation of the ATC maximizes the efficiency and benefits of the ATC by achieving maximum performance results for the application and/or workload.

### BACKGROUND OF THE DISCLOSURE

### Field of the Disclosure

Embodiments of the present disclosure generally relate to improved address translation.

### Description of the Related Art

One of the use cases of a multi-tenancy device is where the solid-state drive (SSD) is shared across multiple tenants (i.e., virtual machines (VMs)) without any hypervisor layer between the SSD and the VM. There are a variety of optimizations around memory usage that will be done when the host operating system (OS) (e.g., Windows Server) implements page movement capabilities. The capabilities require address translation service (ATS) and Page Request Interface (PRI) functionality in any peripheral component interconnect express (PCIe) device that is directly accessed by guest VMs. Moving memory pages implies the device will receive PCIe addresses that need to be translated.

When using ATS + PRI, translated addresses can be saved in an address translation cache (ATC). The ATC feature is very expensive since ATC requires a huge memory to be used as the cache buffer (on the order of few megabytes (MBs)) and high-performance lookup operations. ATC significantly increases the area, cost, and power consumption of the device.

One approach to effectively utilize the ATC is a global ATC where all clients globally are served without considering client identification (ID). Another approach is a static ATC attributes approach where the same amount of memory in cache is allocated for each client. Both approaches face challenges in achieving optimal performance results.

There is a need in the art for improved address translation.

### SUMMARY OF THE DISCLOSURE

Rather than simply providing an address translation cache (ATC) with a global approach that ignores client needs or providing a static ATC that ignores performance changes, the ATC allocation can be dynamically adjusted. The dynamic allocation optimizes the overall system performance will constraining the performance of each individual client when necessary. The dynamic approach involves periodically, or strategically, determining whether the currently in use ATC allocation results in the performance desired. The dynamic reallocation of the ATC maximizes the efficiency and benefits of the ATC by achieving maximum performance results for the application and/or workload.

In one embodiment, a data storage device comprises: a memory device; and a controller coupled to the memory device, wherein the controller is configured to: select a configuration for address translation cache (ATC) attributes for operating the data storage device; operate the data storage device using the configuration; measure performance of the data storage device using the configuration; change from the configuration to a different configuration for the ATC attributes based upon the measuring; and repeat the operating, the measuring, and the changing.

In another embodiment, a data storage device comprises: a memory device; and a controller coupled to the memory device, wherein the controller comprises a host interface module (HIM) comprising: a calibration logic module configured to adjust cache configurations, measure performance of the data storage device, and intelligently select optimal cache configurations; a performance monitor module configured to monitor the performance of the data storage device; and an address translation cache (ATC) configuration module configured to maintain one or more cache configurations to be used for the adjusting by the calibration logic module.

In another embodiment, a data storage device comprises: memory means; and a controller coupled to the memory means, wherein the controller is configured to: measure performance of the data storage device; change address translation cache (ATC) attributes based upon the measuring; operate the data storage device using the changed ATC attributes; save the ATC attributes; repeat the measuring, changing, operating, and saving one or more times; select optimal ATC attributes; and operate the data storage device using the selected optimal ATC attributes.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIG. 2 is a schematic diagram illustrating a multi-tenancy system supporting ATS functionality, according to certain embodiments.

FIG. 3 is a schematic illustration of ATC attributes calibration according to one embodiment.

FIG. 4 is a flowchart illustrating ATC attribute calibration according to one embodiment.

FIG. 5 is a schematic illustration of a system block diagram according to one embodiment.

FIG. 6 is a flowchart illustrating dynamic ATC allocation according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Rather than simply providing an address translation cache (ATC) with a global approach that ignores client needs or providing a static ATC that ignores performance changes, the ATC allocation can be dynamically adjusted. The dynamic allocation optimizes the overall system performance will constraining the performance of each individual client when necessary. The dynamic approach involves periodically, or strategically, determining whether the currently in use ATC allocation results in the performance desired. The dynamic reallocation of the ATC maximizes the efficiency and benefits of the ATC by achieving maximum performance results for the application and/or workload.

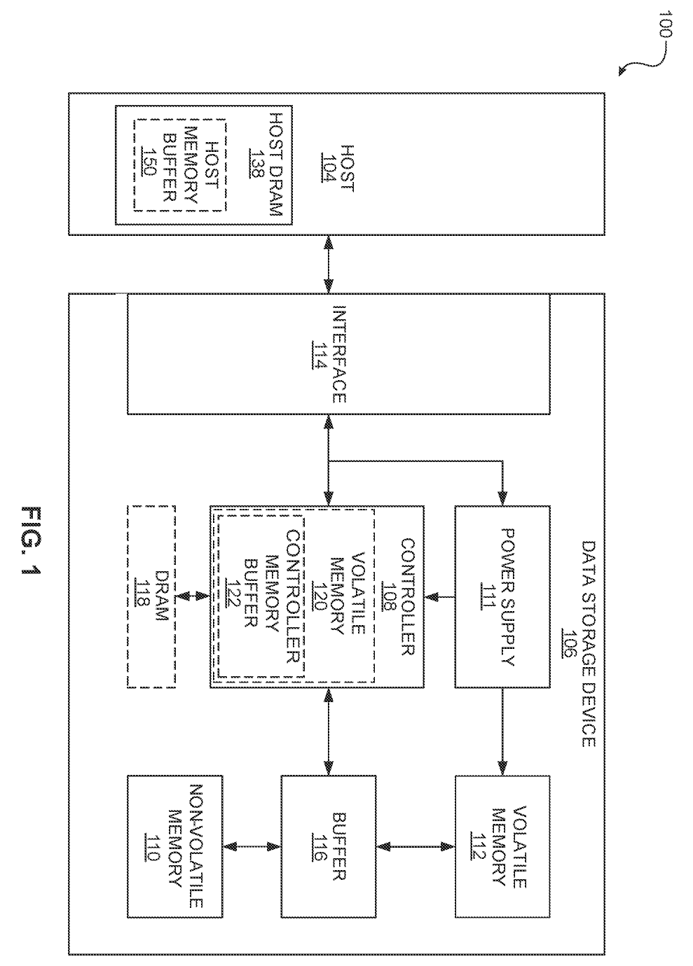

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host dynamic random access memory (DRAM) 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host DRAM 138 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5” data storage device (e.g., an HDD or SSD), 2.5” data storage device, 1.8” data storage device, peripheral component interconnect (PCI), PCI-extended (PCI-X), PCI Express (PCIe) (e.g., PCIe x1, x4, x8, x16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128MB, 256MB, 512MB, 1GB, 2GB, 4GB, 8GB, 16GB, 32GB, 64GB, 128GB, 256GB, 512GB, 1TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVM Flash memory devices may include NAND or NOR-based flash memory devices and may store data based on a charge contained in a floating gate of a transistor for each flash memory cell. In NVM flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). The controller 108 may write data to and read data from NVM flash memory devices at the page level and erase data from NVM flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)). Likewise, the optional DRAM 118 may be utilized to store mapping data, buffered commands, logical to physical (L2P) tables, metadata, cached data, and the like in the optional DRAM 118. In some examples, the data storage device 106 does not include the optional DRAM 118, such that the data storage device 106 is DRAM-less. In other examples, the data storage device 106 includes the optional DRAM 118.

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110. Controller 108 may include circuitry or processors configured to execute programs for operating the data storage device 106.

The controller 108 may include an optional second volatile memory 120. The optional second volatile memory 120 may be similar to the volatile memory 112. For example, the optional second volatile memory 120 may be SRAM. The controller 108 may allocate a portion of the optional second volatile memory to the host device 104 as controller memory buffer (CMB) 122. The CMB 122 may be accessed directly by the host device 104. For example, rather than maintaining one or more submission queues in the host device 104, the host device 104 may utilize the CMB 122 to store the one or more submission queues normally maintained in the host device 104. In other words, the host device 104 may generate commands and store the generated commands, with or without the associated data, in the CMB 122, where the controller 108 accesses the CMB 122 in order to retrieve the stored generated commands and/or associated data.

ATC is a feature in PCIe where the data storage device receives untranslated addresses from a host device and before using those addresses, the addresses need to be translated by a translation agent (TA). The TA has a table of translated addresses and corresponding untranslated addresses. The host device sends, for example, a command to the endpoint (i.e., data storage device), and in the command there is an untranslated address. Before using the address, the endpoint first needs to obtain the translated address. The endpoint interacts with the TA to obtain the translated address. Upon receipt of the translated address from the TA, the endpoint will be able to use the translated address and store the translated address in the ATC.

In order to increase the performance and reduce the overhead over the link, the data storage device will negotiate with the TA in order to obtain the translated address. Before starting the negotiation with the TA, the end point first checks to see if the translated address in the ATC. If the translated address is in the ATC, the endpoint will use the translated address stored in the ATC. Otherwise, the endpoint will start the interaction with the TA.

In a multi-host or multi-tenancy device, such as when there are multiple functions, multiple physical functions, multiple virtual functions, or multiple hosts in the system, the system uses only a single ATC for all hosts or functions such that all hosts or functions have access to the same ATC. The instant disclosure involves how to optimize the system for performances quality, QoS point of view. Stated another way, the disclosure involves how to increase performance while managing the ATC.

As noted above, for a global ATC, all functions will be able to use the ATC with no special policy. For example, data will be evicted from the ATC based upon least recently used (LRU) or some other criteria. However, there is no space reserved for any specific function in global ATC. The other approach mentioned above is the static ATC attribute where at the beginning, the ATC is allocated for the functions/hosts, such as when a function needs a higher QoS compared to other functions. For the function that needs a higher QoS, perhaps half of the ATC can be allocated to the function and the remainder allocated to the remaining functions so that one function will be able to provide better performance compared to the other functions. With the static ATC attribute, the ATC distribution does not change. The disclosure focuses on dynamic allocation of the ATC to improve performance.

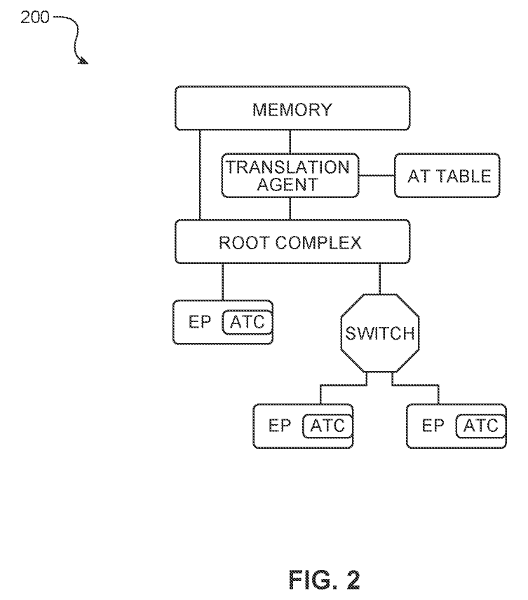

FIG. 2 is a schematic diagram illustrating a multi-tenancy system 200 supporting ATS functionality, according to certain embodiments. A TA services memory translation requests. The ATC is referred to as a translation look-aside buffer (TLB) in the TA. When the ATS enabled SSD device accesses system memory, the SSD shall cache translated addresses in an internal ATC. The ATC is different from the TLB translation cache used by the host. The ATS enabled SSD device shall implement and maintain a designated ATC to minimize performance dependencies on the TA and alleviate TA resource pressure.

Examples of PCIe addresses to be translated include: caching of submission queue (SQ) and completion queue (CQ) address ranges; SQ entry decoding including standard decoding of the data pointer for read or write that submit translation requests immediately, PRPs and SGLs that decode the data pointers and follow linked lists and upper bound of translations per large commands equal a rate match PRI translations with Gen5 bandwidth (BW) maximums, and DIX translation requests for metadata pointers and associated linked lists of addresses.

The ATC serves as a global resource shared among multiple clients, including PCIe functions and applications. The performance and QoS of the memory device rely on the chosen attributes of the shared resource. There is a significant advantage in employing an algorithm capable of detecting the optimal ATC attributes that yield the best performance results.

As discussed herein, an apparatus is designed to intricately calibrate the attributes of the ATC, aiming to optimize the overall system performance while constraining the performance of each individual client as necessary. The dynamic calibration process may be executed at regular intervals or triggered otherwise, ensuring that the current ATC attributes align seamlessly with the present set of workloads, configurations, system conditions, and operational constraints.

The algorithm not only takes into consideration the immediate environment but also analyzes historical data as to gain a comprehensive understanding of the system's performance trends over time. By doing so, the algorithm effectively adapts to varying conditions, ensuring the continuous optimization of the ATC attributes.

At the core of the apparatus is the algorithm's capability to determine and recommend the optimal ATC size and eviction policy for each PCIe function or application. The approach ensures that the unique characteristics and requirements of each client are addressed, contributing to the maximization of the overall system performance. The primary advantage is to maximize the benefits and efficiency of the ATC by selecting optimal cache attributes, thereby achieving maximum performance results for the current application or workload.

As discussed herein, the ATC can be used dynamically by finding the correct attributes for each and every host or function, from the ATC point of view, in order to maximize the performance and QoS. The dynamic calibration approach involves playing with the configuration of the ATC, whether the ATC starts with a global configuration, static ATC attributes, or something else, to obtain the optimum configuration. For example, what is the size of the ATC for each and every host or function and what would be the eviction policy for each and every host or function can be considered. For example, one host can have one eviction policy while another host can have a different eviction policy. The optimization involves trying to play with the configurations in order to find the best configuration for the specific system where best means obtaining the best performance and best QoS results.

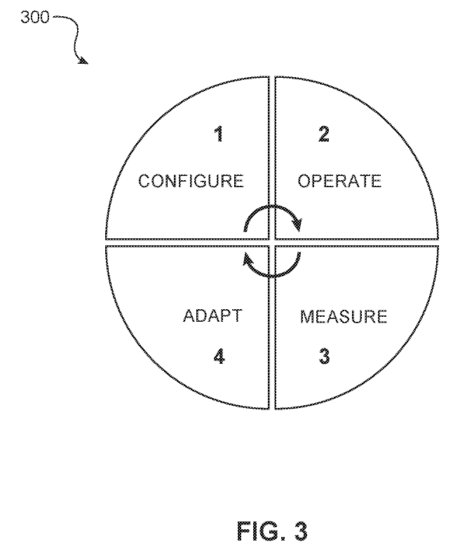

FIG. 3 is a schematic illustration of ATC attributes calibration according to one embodiment. In FIG. 3, there are several phases that are going to repeat. First, configuring the system, especially the ATC based upon the eviction policy for each and every host and determining the size to allocate for each and every host. Then, operating using the configuration, measuring the results, and after some time, adapting the configuration. Collectively, the configuring, operating, measuring, and adapting is the calibration process. The calibration process will repeat until reaching a point that is good enough for the specific system. Additionally, from time to time, the calibration will repeat to recalibrate the system.

To perform the calibration, there are the some parameters to take into account, such as the maximum allowed bandwidth for each a client in the system, the namespaces that are used for each and every client, the priority, the performance QoS requirements for each for each host, the utilization, the capacity, the frequency, and history data collected for a specific host.

As noted above, the system may be calibrated from time to time to find the optimal ATC attributes. Initially, the ATC attributes are configured with set of default parameters. Then, the system is activated while having transfers over the link. During this time, the performance is measured, the results are analyzed, and the configuration ATC attributes are adapted. The process is repeated until finding the optimal configurations.

If the default ATC configuration is a global ATC, by ignoring the client ID, all clients are initially permitted unrestricted access to the ATC. The initial configuration is assessed as a baseline. Subsequently, the configuration is systematically adjusted and measured multiple times to explore potential improvements. The configuration that yields optimal results is then selected.

Several parameters, among others, are considered when defining an optimal cache configuration: maximum allowed bandwidth for each client; attached namespaces for each client; client priority; client utilization (e.g., capacity, frequency, etc.); and historical data collection on the clients.

It is to be noted that a client can be either a physical or virtual PCIe function. Additionally, a client may be a specific Process Address Space Identification (ID) (PASID), used in a paravirtualized environment to identify a specific application. For the purposes of the disclosure, Virtual Function ID, Physical Function ID, and Process Address Space ID may be all be used depending on the use case and host configuration.

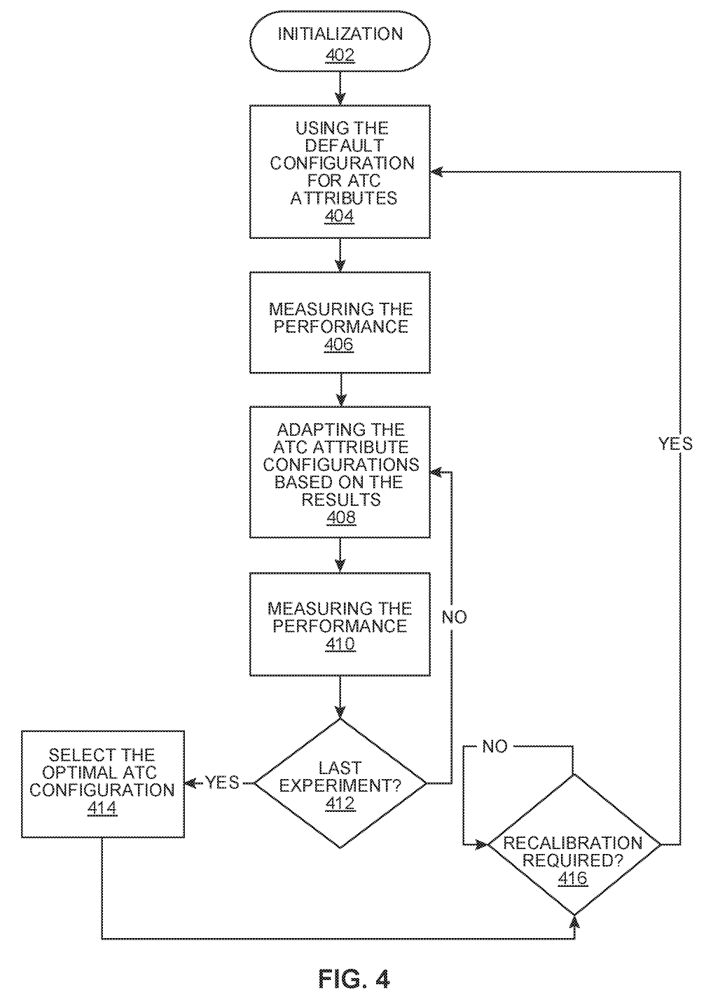

FIG. 4 illustrates a flowchart 400 summarizing the method for calibrating ATC attributes according to one embodiment. At a high level, the process begins by measuring the performance results of the default configuration, which does not take the client ID into account in ATC management. Subsequently, based on the results, the configuration is adjusted and re-evaluated. The iterative process continues until the optimal configuration is identified and selected for use. Periodic recalibration may occur to maintain optimal performance over time.

More specifically, the process starts with the initialization at block 402. Then, the system operates with the default configuration for the ATC attributes at block 404. For example, the default could be global ATC. Then, the system measures the performance at block 406 based upon some traffic, such as read/write commands over the bus. Based on the measurement, and after some time, the ATC attribute configuration is adapted based on the results at block 408 and then measuring the performance at block 410. Then, a check is made at block 412 regarding whether the last experiment has occurred. If not, then the process goes back to block 408 where the system will adapt and change the configuration and then measure the result until the last experiment is completed. Once the last experiment is completed, then the optimal ATC configuration is selected at block 414 based on the results that were measured. The system will continue working in the selected mode and then will check to see if recalibration is beneficial. Recalibration may occur from time to time, such as every hour or if there is some inefficiency in the results or performance drop. Based on the decision to recalibrate, the process will repeat again.

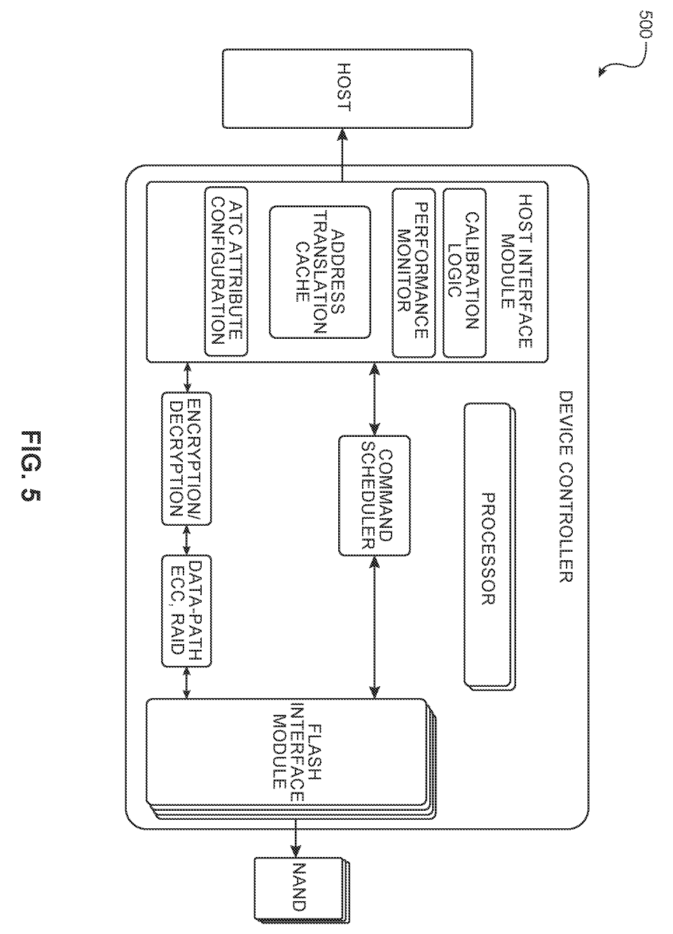

FIG. 5 is a schematic illustration of a system block diagram 500 according to one embodiment. FIG. 5 is the system block diagram 500 that includes the host interface module (HIM) that includes the calibration logic performance monitor in order to measure the results and QoS performance. The HIM also has the ATC attribute configuration and that will be changed.

The HIM integrates the ATC and a dynamic calibration logic module. The calibration logic module actively adjusts the cache configurations, measures performance, and intelligently selects the optimal cache configuration. The objective is to achieve the best performance results tailored to the unique characteristics of the specific system, workload, and configurations.

The results of the optimal configuration for the ATC may depend on the workload. When there is a change in the workload, reconfiguration may be needed because the results of the optimal configuration of the ATC depends on the workload. There are also some static configurations that may have impacts on the results, such as what are the namespaces that are attached for a function that are more sensitive to latency, for example, and therefore the result would be to allocate more cache size to those specific functions, and so on. For example, whether the namespace is SLC or associated with SLC which usually has more performance compared to TLC or QLC and therefore needs more allocation. Cache size may also adapt the eviction policy to the specific namespace. Finally, the frequency of triggering the calibration may depend on several attributes. For example, if the system detects any performance drop, any change in the workload, or simply from time to time even there is nothing detected, the system can be recalibrated.

In one embodiment, the function cache allocation is directed by the workload, analyzed historically. Such an allocation is primarily of value in enterprise compute use-cases, where the benefit of ATS in a specific function can be derived by analysis of previous I/O transactions.

In another embodiment, the function cache allocation is influenced by a static configuration. For example, specific namespaces attached to a function may indicate a greater sensitivity to latency and a higher allocation for ATS resources. Specific use cases include an automotive multi-host environment where some of the tenants may be preconfigured to use an SLC namespace. In automotive multi-host environment example, the allocation of ATS resources would be weighted towards functions that are pre-defined to require more responsiveness.

In another embodiment, the frequency of triggering the presented calibration scheme may be modified according to different factors. For example, the calibration may be triggered at a higher rate when the measured performance is relatively low, while triggered at a lower rate when the measured performance is relatively high. Thresholds can provided to determine the low/high performance. The value may also be continuous.

Frequency of triggering the calibration may also depend on external conditions and workload type. When the workload is highly intensive and the system resources are needed to maintain the workload, the frequency of calibration may be lower, while when the workload is less intensive, more frequency calibration may be conducted.

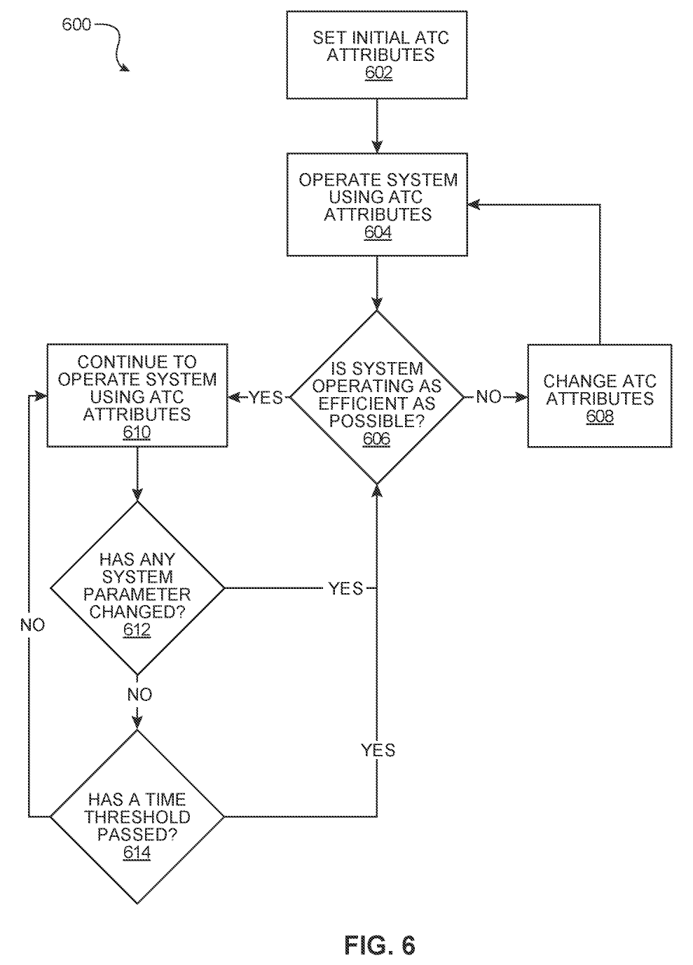

FIG. 6 is a flowchart 600 illustrating dynamic ATC allocation according to one embodiment. Initially, the initial ATC attributes are chosen or set at block 602. The initial ATC attributes may be any ATC attribute distribution, such as a global ATC, static ATC, or simply the last ATC attribute setting utilized by the system just to name a few. Once the initial ATC attributes are set, then system operates using those ATC attributes at block 604. By operating it is understood to mean any general operation such as actual read/write command processing or system generated dummy commands to test the ATC attribute setting. The performance of the system operation using the ATC attribute settings is measured.

The system efficiency is then determined at block 606. Basically, a determination is made regarding whether the system is operating as efficiently as possible. If the system is not operating as efficiently as possible, then the ATC attributes are changed at block 608 and the system then operates using the new ATC attributes at block 606.

If the system is operating as efficient as possible, then the system continues to operate using the same ATC attributes at block 610. The system keeps track of any changes that may occur and/or whether a time threshold has been exceeded. If any system parameter has changed at block 612, then the process returns to block 606, but if no parameters have changed, then the process continues to block 614 to determine if a time threshold has passed. If a time threshold has passed, then the process continues back to block 606, but continues to operate at block 610 if the time threshold has not passed. It is to be noted that blocks 612 and 614 may occur in any order, and both blocks need not be present.

By dynamically allocating the ATC by selecting optimal cache attributes, the ATC achieves maximum performance results for the current application or workload. The efficiency can be measured in performance while assuming the same ATC size.

In one embodiment, a data storage device comprises: a memory device; and a controller coupled to the memory device, wherein the controller is configured to: select a configuration for address translation cache (ATC) attributes for operating the data storage device; operate the data storage device using the configuration; measure performance of the data storage device using the configuration; change from the configuration to a different configuration for the ATC attributes based upon the measuring; and repeat the operating, the measuring, and the changing. The configuration is a global ATC configuration. The configuration is a static ATC attribute configuration. The controller is configured to: select a working ATC configuration; operate the data storage device using the working configuration; and determine whether a recalibration should occur after operating the data storage device using the working ATC configuration. The controller, after determining that a recalibration should occur, is configured to: change from the working ATC configuration to a new configuration for the ATC attributes; operate the data storage device using the new configuration; measure performance of the data storage device using the new configuration; select a new working ATC configuration for the data storage device; and operate the data storage device using the selected new working ATC configuration. The controller is configured to repeat the changing to a new configuration, operating using the new configuration, and measuring performance using the new configuration. The controller comprises a host interface module (HIM) and wherein the ATC is disposed in the HIM. The HIM comprises an ATC attribute configuration module, a performance monitor module, and a calibration logic module. The controller is configured to interact with one or more of the following: a virtual function; a physical function; a process address space identification (ID) (PASID); and combinations thereof. The configuration is weighted towards functions that are predetermined to necessitate higher responsiveness compared to other functions.

In another embodiment, a data storage device comprises: a memory device; and a controller coupled to the memory device, wherein the controller comprises a host interface module (HIM) comprising: a calibration logic module configured to adjust cache configurations, measure performance of the data storage device, and intelligently select optimal cache configurations; a performance monitor module configured to monitor the performance of the data storage device; and an address translation cache (ATC) configuration module configured to maintain one or more cache configurations to be used for the adjusting by the calibration logic module. The calibration logic module is configured to adjust cache configurations based upon historically analyzed workload. The calibration logic module is configured to adjust cache configurations with a preconfigured weight towards functions that necessitate more responsiveness as compared to other functions that necessitate less responsiveness. Calibration performed by the calibration logic module is triggered at a higher rate when measured performance is lower than a threshold compared to when measured performance is equal to or greater than the threshold. Calibration performed by the calibration logic module is triggered based upon external conditions and workloads of functions. Calibration frequency is decreased when workload is increased. The modules operate dynamically.

In another embodiment, a data storage device comprises: memory means; and a controller coupled to the memory means, wherein the controller is configured to: measure performance of the data storage device; change address translation cache (ATC) attributes based upon the measuring; operate the data storage device using the changed ATC attributes; save the ATC attributes; repeat the measuring, changing, operating, and saving one or more times; select optimal ATC attributes; and operate the data storage device using the selected optimal ATC attributes. The controller is configured to determine whether recalibration of ATC attributes should occur, wherein the determining occurs after the operating the data storage device using the selected optimal ATC attributes. The measuring, changing, selecting, and saving occur in a host interface module (HIM) of the controller.

While the foregoing is directed to embodiments of the present disclosure, other and further embodiments of the disclosure may be devised without departing from the basic scope thereof, and the scope thereof is determined by the claims that follow.

What is claimed is:

1. A data storage device, comprising:
a memory device; and
a controller coupled to the memory device, wherein the controller is configured to:
select a configuration for address translation cache (ATC) attributes for operating the data storage device;
operate the data storage device using the configuration;
measure performance of the data storage device using the configuration;
change from the configuration to a different configuration for the ATC attributes based upon the measuring; and
repeat the operating, the measuring, and the changing.

2. The data storage device of claim 1, wherein the configuration is a global ATC configuration.

3. The data storage device of claim 1, wherein the configuration is a static ATC attribute configuration.

4. The data storage device of claim 1, wherein the controller is configured to:
select a working ATC configuration;
operate the data storage device using the working configuration; and
determine whether a recalibration should occur after operating the data storage device using the working ATC configuration.

5. The data storage device of claim 4, wherein the controller, after determining that a recalibration should occur, is configured to:
change from the working ATC configuration to a new configuration for the ATC attributes;
operate the data storage device using the new configuration;
measure performance of the data storage device using the new configuration;
select a new working ATC configuration for the data storage device; and
operate the data storage device using the selected new working ATC configuration.

6. The data storage device of claim 5, wherein the controller is configured to repeat the changing to a new configuration, operating using the new configuration, and measuring performance using the new configuration.

7. The data storage device of claim 1, wherein the controller comprises a host interface module (HIM) and wherein the ATC is disposed in the HIM.

8. The data storage device of claim 7, wherein the HIM comprises an ATC attribute configuration module, a performance monitor module, and a calibration logic module.

9. The data storage device of claim 1, wherein the controller is configured to interact with one or more of the following:
a virtual function;
a physical function;
a process address space identification (ID) (PASID); and
combinations thereof.

10. The data storage device of claim 1, wherein the configuration is weighted towards functions that are predetermined to necessitate higher responsiveness compared to other functions.

11. A data storage device, comprising:
a memory device; and
a controller coupled to the memory device, wherein the controller comprises a host interface module (HIM) comprising:
a calibration logic module configured to adjust cache configurations, measure performance of the data storage device, and intelligently select optimal cache configurations;
a performance monitor module configured to monitor the performance of the data storage device; and
an address translation cache (ATC) configuration module configured to maintain one or more cache configurations to be used for the adjusting by the calibration logic module.

12. The data storage device of claim 11, wherein the calibration logic module is configured to adjust cache configurations based upon historically analyzed workload.

13. The data storage device of claim 11, wherein the calibration logic module is configured to adjust cache configurations with a preconfigured weight towards functions that necessitate more responsiveness as compared to other functions that necessitate less responsiveness.

14. The data storage device of claim 11, wherein calibration performed by the calibration logic module is triggered at a higher rate when measured performance is lower than a threshold compared to when measured performance is equal to or greater than the threshold.

15. The data storage device of claim 11, wherein calibration performed by the calibration logic module is triggered based upon external conditions and workloads of functions.

16. The data storage device of claim 15, wherein calibration frequency is decreased when workload is increased.

17. The data storage device of claim 11, wherein the modules operate dynamically.

18. A data storage device, comprising:
memory means; and
a controller coupled to the memory means, wherein the controller is configured to:
measure performance of the data storage device;
change address translation cache (ATC) attributes based upon the measuring;
operate the data storage device using the changed ATC attributes;
save the ATC attributes;
repeat the measuring, changing, operating, and saving one or more times;
select optimal ATC attributes; and
operate the data storage device using the selected optimal ATC attributes.

19. The data storage device of claim 18, wherein the controller is configured to determine whether recalibration of ATC attributes should occur, wherein the determining occurs after the operating the data storage device using the selected optimal ATC attributes.

20. The data storage device of claim 18, wherein the measuring, changing, selecting, and saving occur in a host interface module (HIM) of the controller.
